(19) United States
(12) Patent Application Publication
(10) Pub. No.: US 2025/0124275 A1
(43) Pub. Date: Apr. 17, 2025

(54) METHODS AND SYSTEMS FOR DETERMINING SUITABLE PRODUCTS AND OPERATING PARAMETERS FOR PERFORMING A TASK

(71) Applicant: Mastercard international incorporaton, Purchase, NY (US)

(72) Inventor: Harsimran Bhasin, New Delhi (IN)

(21) Appl. No.: 18/486,122

(22) Filed: Oct. 12, 2023

(51) Int. Cl. G06N 3/08

(52) U.S. Cl. CPC G06N 3/08

(57) ABSTRACT

Methods and server systems for determining suitable products and operating parameters for performing a task are described herein. Method performed by server system includes receiving task-specific query from entity and determining the task based on the task-specific query. Method includes accessing product-specific data, entity-specific data, and predefined rules from a database based on entity and task. Herein, the product-specific data includes information related to each product, the entity-specific data includes information related to the entity, and the predefined rules indicates rules for implementing the plurality of products. Method includes generating and transmitting, via large language machine learning model, a query response message based on product-specific data, entity-specific data, and predefined rules. Such that the query response message indicates task-specific information that includes a list of the one or more suitable products and operating parameters corresponding to each suitable product for performing the task.

### TECHNICAL FIELD

The present disclosure relates to artificial intelligence-based processing systems and, more particularly, to electronic methods and complex processing systems for determining one or more suitable products from a plurality of products and one or more operating parameters corresponding to one or more suitable products for performing a task by an entity.

### BACKGROUND

Within the financial sector, there is an ever-increasing number of financial products and services offered by payment processors such as MasterCard® to their customers, such as, issuing banks and acquiring banks. As may be understood, these products range from fraud management, payment processing, payment facilitation, decision intelligence, fund management, and the like. The goal of such products is to improve the existing capabilities of the issuing banks and the acquiring banks while performing various tasks, such as, predicting fraud, fund management, and the like. It is generally quite difficult for customers to determine which product or a group of products is suitable to perform a particular task from a plurality of products offered by the payment processors. To that end, such determination of suitable products is done by the customers based on their research or based on recommendations offered by the product teams associated with the payment processor. However, since each customer's needs and requirements are different or unique, the customers are generally unable to leverage the full potential of such products.

Further, due to the vast nature of the products being offered, it becomes difficult for the customers to conduct proper research on their own. Furthermore, even the product teams are unable to recommend the most suitable products to their customer due to a lack of in-depth technical knowledge or improper training. Additionally, since the use case of each customer is also unique due to their own institutional policies or regional policies implemented by regulatory authorities, each product has to be tuned specially to the needs of the customers. However, determining the most optimal operating parameters for each customer and tuning the operating parameters of each suitable product to the customer-specific use case is a complex process. Generally, this process is done manually by the product development team for each product separately, which is a manual and time-consuming process. Further, in a scenario where multiple products have to work in tandem to perform the specific task of the customer, the product development teams might have to collaborate to optimize the products accordingly, which can lead to delays to administrative issues.

Thus, there exists a technological need for developing technical solutions for determining one or more suitable products from a plurality of products and one or more operating parameters corresponding to one or more suitable products for performing a task by an entity.

### SUMMARY

Various embodiments of the present disclosure provide methods and systems for determining one or more suitable products from a plurality of products and one or more operating parameters corresponding to one or more suitable products for performing a task by an entity.

In an embodiment, a computer-implemented method for determining one or more suitable products from a plurality of products for performing a task by an entity is disclosed. The computer-implemented method performed by a server system includes receiving a task-specific query from an entity. Herein, the task-specific query indicates a query for requesting task-specific information related to one or more suitable products from a plurality of products to be used for performing a task by the entity. Further, the method includes determining the task to be performed by the entity based, at least in part, on the task-specific query. Further, the method includes accessing product-specific data, entity-specific data, and a set of predefined rules from a database associated with the server system based, at least in part, on the entity and the task.

Herein, the product-specific data includes information related to each product of the plurality of products. Further, the entity-specific data includes information related to the entity. Furthermore, the set of predefined rules indicates rules for implementing the plurality of products. Further, the method includes generating via a Large Language Machine learning (LLM) model, a query response message based, at least in part, on the product-specific data, the entity-specific data, and the set of predefined rules. Herein, the query response message indicates task-specific information related to the one or more suitable products for performing the task. The task-specific information includes at least a list of the one or more suitable products and the one or more operating parameters corresponding to each suitable product of the one or more suitable products for performing the task. The method further includes transmitting the query response message to the entity in response to the task-specific query.

In another embodiment, a server system is disclosed. The server system includes a communication interface and a memory including executable instructions. The server system also includes a processor communicably coupled to the memory. The processor is configured to execute the instructions to cause the server system, at least in part, to receive a task-specific query from an entity. Herein, the task-specific query indicates a query for requesting task-specific information related to one or more suitable products from a plurality of products to be used for performing a task by the entity. Further, the server system is caused to determine the task to be performed by the entity based, at least in part, on the task-specific query. Further, the server system is caused to access product-specific data, entity-specific data, and a set of predefined rules from a database associated with the server system based, at least in part, on the entity and the task.

Herein, the product-specific data includes information related to each product of the plurality of products, the entity-specific data includes information related to the entity and the set of predefined rules indicates rules for implementing the plurality of products. Further, the server system is caused to generate via a Large Language Machine learning (LLM) model, a query response message based, at least in part, on the product-specific data, the entity-specific data, and the set of predefined rules. Herein, the query response message indicates task-specific information related to the one or more suitable products for performing the task. The task-specific information includes at least a list of the one or more suitable products and the one or more operating parameters corresponding to each suitable product of the one or more suitable products for performing the task. Further, the server system is caused to transmit the query response message to the entity in response to the task-specific query.

In yet another embodiment, a non-transitory computer-readable storage medium is disclosed. The non-transitory computer-readable storage medium includes computer-executable instructions that, when executed by at least a processor of a server system, cause the server system to perform a method. The method includes receiving a task-specific query from an entity. Herein, the task-specific query indicates a query for requesting task-specific information related to one or more suitable products from a plurality of products to be used for performing a task by the entity. Further, the method includes determining the task to be performed by the entity based, at least in part, on the task-specific query. Further, the method includes accessing product-specific data, entity-specific data, and a set of predefined rules from a database associated with the server system based, at least in part, on the entity and the task.

Herein, the product-specific data includes information related to each product of the plurality of products. Further, the entity-specific data includes information related to the entity. Furthermore, the set of predefined rules indicates rules for implementing the plurality of products. Further, the method includes generating via a Large Language Machine learning (LLM) model, a query response message based, at least in part, on the product-specific data, the entity-specific data, and the set of predefined rules. Herein, the query response message indicates task-specific information related to the one or more suitable products for performing the task. The task-specific information includes at least a list of the one or more suitable products and the one or more operating parameters corresponding to each suitable product of the one or more suitable products for performing the task. The method further includes transmitting the query response message to the entity in response to the task-specific query.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

For a more complete understanding of example embodiments of the present technology, reference is now made to the following descriptions taken in connection with the accompanying drawings in which:

FIG. 1 illustrates an exemplary representation of an environment related to at least some example embodiments of the present disclosure;

FIG. 2 illustrates a simplified block diagram of a server system, in accordance with an embodiment of the present disclosure;

FIG. 3 illustrates a schematic representation of the architecture of the LLM model, in accordance with an embodiment of the present disclosure;

FIG. 4 illustrates a Graphical User Interface (GUI), in accordance with various embodiments of the present disclosure;

FIG. 5 illustrates a process flow diagram depicting a method for generating a query response message in response to a task-specific query from an entity for performing a task, in accordance with an embodiment of the present disclosure;

FIG. 6 illustrates a simplified block diagram of an acquirer server, in accordance with an embodiment of the present disclosure;

FIG. 7 illustrates a simplified block diagram of an issuer server, in accordance with an embodiment of the present disclosure; and

FIG. 8 illustrates a simplified block diagram of a payment server, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification does not necessarily all refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entirely hardware embodiment, an entirely software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

The terms “account holder”, “user”, “cardholder”, “consumer”, and “buyer” are used interchangeably throughout the description and refer to a person who has a payment account or a payment card (e.g., credit card, debit card, etc.) associated with the payment account, that will be used by them at a merchant to perform a payment transaction. The payment account may be opened via an issuing bank or an issuer server.

The term “merchant”, used throughout the description generally refers to a seller, a retailer, a purchase location, an organization, or any other entity that is in the business of selling goods or providing services, and it can refer to either a single business location or a chain of business locations of the same entity.

The terms “payment network” and “card network” are used interchangeably throughout the description and refer to a network or collection of systems used for the transfer of funds through the use of cash substitutes. Payment networks may use a variety of different protocols and procedures in order to process the transfer of money for various types of transactions. Payment networks are companies that connect an issuing bank with an acquiring bank to facilitate an online payment. Transactions that may be performed via a payment network may include product or service purchases, credit purchases, debit transactions, fund transfers, account withdrawals, etc. Payment networks may be configured to perform transactions via cash substitutes that may include payment cards, letters of credit, checks, financial accounts, etc. Examples of networks or systems configured to perform or function as payment networks include those operated by such as MasterCard®.

The term “payment card”, used throughout the description, refers to a physical or virtual card linked with a financial or payment account that may be presented to a merchant or any such facility to fund a financial transaction via the associated payment account. Examples of payment cards include, but are not limited to, debit cards, credit cards, prepaid cards, virtual payment numbers, virtual card numbers, forex cards, charge cards, e-wallet cards, and stored-value cards. A payment card may be a physical card that may be presented to the merchant for funding the payment. Alternatively, or additionally, the payment card may be embodied in the form of data stored in a user device, where the data is associated with a payment account such that the data can be used to process the financial transaction between the payment account and a merchant's financial account.

The term “payment account”, used throughout the description refers to a financial account that is used to fund a financial transaction. Examples of financial account include, but are not limited to a savings account, a credit account, a checking account, and a virtual payment account. The financial account may be associated with an entity such as an individual person, a family, a commercial entity, a company, a corporation, a governmental entity, a non-profit organization, and the like. In some scenarios, the financial account may be a virtual or temporary payment account that can be mapped or linked to a primary financial account, such as those accounts managed by payment wallet service providers, and the like.

The terms “payment transaction”, “financial transaction”, “event”, and “transaction” are used interchangeably throughout the description and refer to a transaction or transfer of payment of a certain amount being initiated by the cardholder. More specifically, they refer to electronic financial transactions including, for example, online payment, payment at a terminal (e.g., Point of Sale (POS) terminal), and the like. Generally, a payment transaction is performed between two entities, such as a buyer and a seller. It is to be noted that a payment transaction is followed by a payment transfer of a transaction amount (i.e., monetary value) from one entity (e.g., issuing bank associated with the buyer) to another entity (e.g., acquiring bank associated with the seller), in exchange of any goods or services.

### Overview

Various embodiments of the present disclosure provide methods, systems, user devices, and computer program products for determining one or more suitable products from a plurality of products and one or more operating parameters corresponding to one or more suitable products for performing a task by an entity.

In an embodiment, a server system that may be a payment server associated with a payment network is configured to receive a task-specific query from an entity. In one example, the entity is at least one of an issuer server associated with an issuing bank and an acquirer server associated with an acquiring bank. Herein, the task-specific query indicates a query for requesting task-specific information related to one or more suitable products from a plurality of products to be used for performing a task by the entity. In particular, the server system is configured to facilitate a display of a Graphical User Interface (GUI) on an electronic device associated with the entity such that the GUI enables the entity to transmit the task-specific query to the server system as a prompt. In response to this task-specific query, the server system is configured to determine the task to be performed by the entity based, at least in part, on the task-specific query. Then, the server system is configured to access product-specific data, entity-specific data, and a set of predefined rules from a database associated with the server system based, at least in part, on the entity and the task. In various examples, the product-specific data may include information related to each product of the plurality of products, the entity-specific data may include information related to the entity and the set of predefined rules may indicate rules for implementing or operating the plurality of products. In various non-limiting examples, the information related to each product of the plurality of products includes at least product-related presentation information, product-related confluence page information, product-related management information, and the like.

In another embodiment, the server system is configured to generate via a Large Language Machine learning (LLM) model, a query response message based, at least in part, on the product-specific data, the entity-specific data, and the set of predefined rules. In various non-limiting examples, the LLM model may include one or more open-source pre-trained large language models. It is noted that the query response message indicates task-specific information related to one or more suitable products for performing the task. Herein, the task-specific information includes a list of one or more suitable products and one or more operating parameters corresponding to each suitable product of the one or more suitable products for performing the task. Herein, one or more operating parameters corresponding to each suitable product include at least a threshold value for each suitable product for performing the task by the entity. In particular, the server system is first configured to determine a context behind the task to be performed by the entity based, at least in part, on the task-specific query. Further, the server system is configured to generate a contextual prompt based, at least in part, on the determined context. Herein, the contextual prompt indicates a request for one or more operating parameters for each suitable product. Then, the server system is configured to provide both of the query response message together or followed by the contextual prompt as input to the LLM model. It is understood that the contextual prompt can reinforce or force the LLM model to focus on numerical values beyond a certain threshold, thereby eliminating factual hallucination.

In a particular embodiment, the server system is configured to train the LLM model based, at least in part, on the product-specific data and the entity-specific data. Herein, the LLM model is configured to identify one or more suitable products for performing the task by the entity. Further, the server system determines via the LLM model, the task-specific information related to one or more suitable products based, at least in part, on the set of predefined rules and generates the query response message based, at least in part, on the task-specific information related to the one or more suitable products.

In another embodiment, the server system is configured to transmit the query response message to the entity in response to the task-specific query. In particular, the server system is configured to facilitate a display of the query response message on the GUI in response to the prompt of the task-specific query.

Various embodiments of the present disclosure provide multiple advantages and technical effects while addressing technical problems such as how to determine one or more suitable products from a plurality of products based on the task and requirements of an entity. To that end, the various embodiments of the present disclosure provide an approach for determining one or more suitable products from a plurality of products and one or more operating parameters corresponding to one or more suitable products for performing a task by an entity. For instance, the server system is configured to use an LLM model, i.e., a generative model to provide an interface that may be used by the entity to ask queries and receive responses. This chat-prompt-based approach is convenient and quick and enables the entity to determine the exact one or more suitable products along with their corresponding one or more operating parameters for performing a particular task. It is noted that entity-specific data enables the LLM model to tune one or more operating parameters for each suitable product accordingly with the internal policies and the regulations associated with the entity.

For instance, the operating parameters may represent threshold values for various score based products offered by the payment processor. As may be understood, this aspect of the present disclosure allows each suitable product to be tuned to the needs or requirements of the entity (or customer). Further, the LLM model is also able to utilize the product-related data to determine a suitable combination of the available products to meet the requirements of the entity based on the initial query prompt. Such aspects enable timely deployment of one or more suitable products while leveraging the entire potential of these products according to the unique requirements of the entity for performing a particular task.

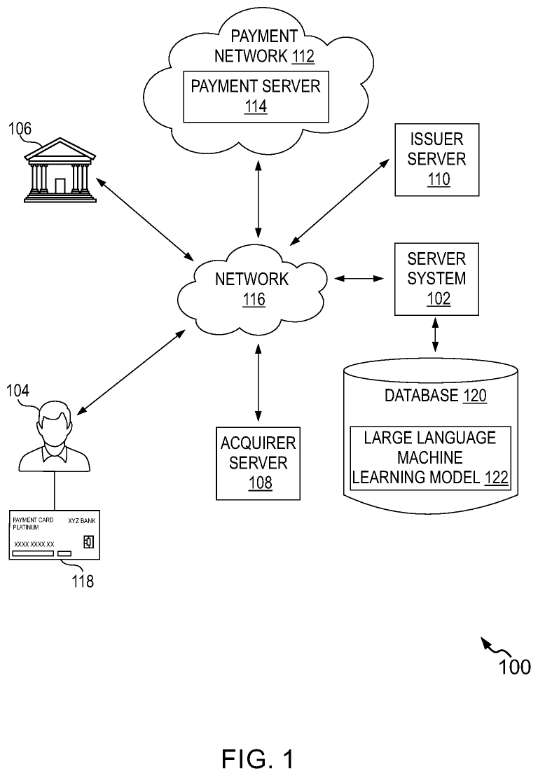

Various embodiments of the present disclosure are described hereinafter with reference to FIGS. 1 to 8.

FIG. 1 illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, determining the requirements of an entity from a task-specific query, determining one or more suitable products from a plurality of products based on the requirements for performing a task, determining one or more operating parameters corresponding to each suitable product of the one or more suitable products for performing the task, and the like.

The environment 100 generally includes a plurality of components such as a server system 102, a cardholder 104, a merchant 106, an acquirer server 108, an issuer server 110, and a payment network 112 including a payment server 114, each coupled to, and in communication with (and/or with access to) a network 116. The network 116 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an Infrared (IR) network, a Radio Frequency (RF) network, a virtual network, and/or another suitable public and/or private network capable of supporting communication among two or more of the parts or components illustrated in FIG. 1, or any combination thereof.

Various entities in the environment 100 may connect to the network 116 in accordance with various wired and wireless communication protocols, such as Transmission Control Protocol/Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 116 may include multiple different networks, such as a private network made accessible by the server system 102 and a public network (e.g., the Internet, etc.) through which the server system 102, the acquirer server 108, the issuer server 110, and the payment server 114 may communicate.

In an embodiment, the cardholder 104 uses a payment card such as payment card 118 to make payment transactions. The cardholder 104 may be any individual, representative of a corporate entity, a non-profit organization, or any other person who is presenting payment account details during an electronic payment transaction. The cardholder 104 may have a payment account issued by an issuing bank (not shown in figures) associated with the issuer server 110 (explained later) and may be provided a payment card 118 with financial or other account information encoded onto the payment card 118 such that the cardholder 104 may use the payment card 118 to initiate and complete a payment transaction using a bank account at the issuing bank.

In an example, the cardholder 104 may use their corresponding electronic devices (not shown in figures) to access a mobile application or a website associated with the issuing bank, or any third-party payment application. In various non-limiting examples, electronic devices may refer to any electronic devices such as, but not limited to, Personal Computers (PCs), tablet devices, Personal Digital Assistants (PDAs), voice-activated assistants, Virtual Reality (VR) devices, smartphones, and laptops.

In an embodiment, the merchant 106 may include retail shops, restaurants, supermarkets or establishments, government and/or private agencies, or any such places equipped with POS terminals, where a cardholder such as the cardholder 104 visits to perform the financial transaction in exchange for any goods and/or services or any financial transactions.

In one scenario, the cardholder 104 may use their corresponding payment account to conduct payment transactions with the merchant 106. Moreover, it may be noted that the cardholder 104 may use their corresponding payment card (such as payment card 118) differently or make the payment transaction using different means of payment. For instance, the cardholder 104 may enter payment account details on an electronic device (not shown) associated with the cardholder 104 to perform an online payment transaction. In another example, the cardholder 104 may utilize the payment card 118 to perform an offline payment transaction. It is understood that generally, the term “payment transaction” refers to an agreement that is carried out between a buyer and a seller to exchange goods or services in exchange for assets in the form of a payment (e.g., cash, fiat currency, digital asset, cryptographic currency, coins, tokens, etc.). For example, the cardholder 104 may enter details of the payment card 118 to transfer funds in the form of fiat currency on an e-commerce platform i.e., an example of the merchant 106 to buy goods.

In one embodiment, the cardholder 104 may be associated with the issuer server 110. In one embodiment, the issuer server 110 is associated with a financial institution normally called an “issuer bank”, “issuing bank” or simply “issuer”, in which a cardholder (e.g., the cardholder 104) may have the payment account, (which also issues a payment card 118, such as a credit card or a debit card), and provides microfinance banking services (e.g., payment transaction using credit/debit cards) for processing electronic payment transactions, to the cardholder (e.g., the cardholder 104).

In an embodiment, the merchant 106 is associated with the acquirer server 108. In an embodiment, each merchant (e.g., the merchant 106) is associated with an acquirer server (e.g., the acquirer server 108). In one embodiment, the acquirer server 108 is associated with a financial institution (e.g., a bank) that processes financial transactions for the merchant 106. This can be an institution that facilitates the processing of payment transactions for physical stores, merchants (e.g., the merchant 106), or institutions that own platforms that make either online purchases or purchases made via software applications possible (e.g., shopping cart platform providers and in-app payment processing providers). The terms “acquirer”, “acquiring bank”, “acquiring bank” or “acquirer server 108” will be used interchangeably herein.

In one embodiment, the payment network 112 may be used by the payment card issuing authorities as a payment interchange network. Examples of the plurality of payment cards 118 include debit cards, credit cards, etc. Similarly, examples of payment interchange networks include but are not limited to, a Mastercard® payment system interchange network. The Mastercard® payment system interchange network is a proprietary communications standard promulgated by Mastercard International Incorporated® for the exchange of electronic payment transaction data between issuers and acquirers that are members of the payment network 112 offered by Mastercard International Incorporated®. (Mastercard is a registered trademark of Mastercard International Incorporated located in Purchase, N.Y.). Further, the various functionalities of the payment network 112 may be implemented using the payment server 114 associated with the payment network 112.

As explained earlier, generally payment processors provide a plurality of products to the issuers and the acquirers in the payment network 112. These plurality of products are for performing a variety of tasks such as fraud management, fund management, and the like. A few examples of the plurality of products include Decision intelligence, Artificial Intelligence scores, and the like. As may be understood, due to the wide applicability of this plurality of products, it becomes very complex for a customer such as the issuers or acquirers to select which products from the plurality of products are suitable for performing the task in their situation. In other words, it is very complicated for the issuers or acquirers to determine which products are best for performing/accomplishing their particular task. For instance, the issuer may wish to manage fraud related to cardholders associated with the issuer. In this scenario, many products from the plurality of products may be useful in determining this fraud; however, it is very complex for the issuer to navigate through this plurality of products to determine which products to deploy for fraud management.

As may be understood, if suitable products are not deployed then the issuer may fail to manage fraud properly despite using the products offered by the payment processors. Thus, leading to financial losses and increased fraud in the payment network. Furthermore, even if suitable products are deployed by the issuer or acquirer, these products have to be tuned for the specific requirements of the issuer or acquirer, this aspect requires a dedicated product development team to tune the same products for different customers. This leads to increased complexity and a waste of time. Furthermore, the operating parameters of each product might have been changed based on the requirements of the issuer, which is also a complex and time-consuming process. For instance, in fraud management product that provides fraud-related scores for each payment transaction will not be useful if there is no threshold value above which the payment transaction may be labeled as fraud. Once it is labeled as fraud, the issuer may choose to decline the transaction, thus preventing fraud. However as may be understood, different issuers will have different risk appetites for fraud; therefore, they require different threshold values. Furthermore, government regulations in a particular region of the issuer may have some additional requirements that the issuer must follow which have to be incorporated by these products as well. As may be understood, recommendations for each product have to be provided to the issuer regarding the threshold values, and the like to ensure optimal performance by the suitable products. This is also a complex and time-consuming endeavor that might suffer from issues due to improper implementation by the issuer due to human error thereby leading to financial losses.

The above-mentioned technical problem among other problems is addressed by one or more embodiments implemented by the server system 102 of the present disclosure. In one embodiment, the server system 102 is configured to perform one or more of the operations described herein.

In one embodiment, the environment 100 may further include a database 120 coupled with the server system 102. In an example, the server system 102 coupled with the database 120 is embodied within the payment server 114, however, in other examples, the server system 102 can be a standalone component (acting as a hub) connected to the acquirer server 108 and the issuer server 110. The database 120 may be incorporated in the server system 102 or may be an individual entity connected to the server system 102 or may be a database stored in cloud storage. In one embodiment, the database 120 may store a Large Language machine learning (LLM) model 122, and other necessary machine instructions required for implementing the various functionalities of the server system 102 such as firmware data, operating system, and the like.

In an example, the LLM model 122 is an AI or ML based model that is configured or trained to perform a plurality of operations. In a non-limiting example, the LLM model 122 can be any open-source pre-trained large language or generative model. In an instance, the LLM model 122 may include one or more open-source pre-trained large language models such that one open-source pre-trained model may be selected from the one or more open-source pre-trained large language models based on a task to be performed by an entity such as the issuer or the acquirer. In one instance, the LLM model 122 may be a transformer-based model. A few examples of open-source pre-trained models include Large Language Model Meta AI (LLaMA)®, Vircuna®, and the like. In an instance, the LLM model 122 may be trained on open source datasets including EnglishCommonCrawl®, C4®, Github®, Wikipedia®, Gutenburg®, ArXiv®, Stack Exchange® and the like. Further, the LLM model 122 may be fine-tuned based on product-specific data, entity-specific data, and a set of predefined rules.

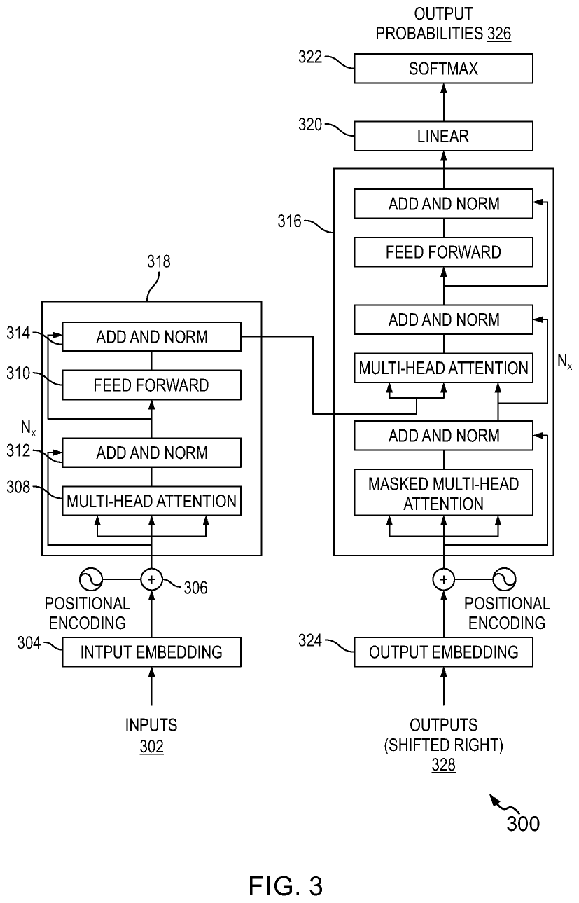

It is noted that the models have been explained in detail later in the present disclosure with reference to FIG. 3. In addition, the database 120 provides a storage location for data and/or metadata obtained from various operations performed by the server system 102.

In an embodiment, the server system 102 is configured to receive a task-specific query from an entity. In various non-limiting examples, the entity may refer to the issuer server 110 associated with an issuing bank, or an acquirer server 108 associated with an acquiring bank. It is noted that the task-specific query may refer to a query from the entity for requesting task-specific information related to one or more suitable products from a plurality of products to be used for performing a task by the entity. Upon receiving the task-specific query, the server system 102 is configured to determine the task to be performed by the entity based, at least in part, on the task-specific query. As may be understood, the task-specific may be a natural language query for requesting the server system 102 to perform an activity (i.e., task). This natural language query has to be analyzed by the server system 102 to determine which task the entity wants to perform. In particular, the server system 102 may utilize any Natural Language Model to determine the task to be performed by the entity. Upon determining the task, the server system 102 is configured to access product-specific data, entity-specific data, and a set of predefined rules from a database such as database 120 associated with the server system based, at least in part, on the entity and the task. In an example, the product-specific data includes information related to each product of the plurality of products. In another example, the entity-specific data includes information related to the entity. In yet another example, the set of predefined rules may include rules for implementing the plurality of products.

Then, the server system 102 is configured to generate using the LLM model 122, a query response message based, at least in part, on the product-specific data, the entity-specific data, and the set of predefined rules. As may be understood, the query response message may include task-specific information related to one or more suitable products for performing the task. In a non-limiting example, the task-specific information may include a list of one or more suitable products and one or more operating parameters corresponding to each suitable product of the one or more suitable products for performing the task. In one implementation, the LLM model 122 may convert the task-specific information into a natural language message suitable to the task-specific query. For example, the LLM model 122 may describe or adapt the task-specific information such that it becomes easier for the entity to comprehend.

It is understood, that the product-specific data enables the LLM model 122 to learn the various features and aspects of the plurality of products, this learning enables the LLM model 122 to determine which products are suitable to the requirements of the entity. Further, training or fine-tuning the LLM model 122 using the entity-specific data enables the LLM model 122 to learn the requirements of the entity such as regulatory requirements due to the location of the entity, preferences of the entity, technical capability of the entity to implement the products and the like. In other words, the entity-specific data helps to fine-tune to selection of suitable products based on the requirements of the entity. Furthermore, the set of predefined rules allows the LLM model 122 to learn the specific rules for implementing the plurality of products. Therefore, the task-specific information generated by the LLM model 122 is fine-tuned to the requirements and the task to be performed by the entity.

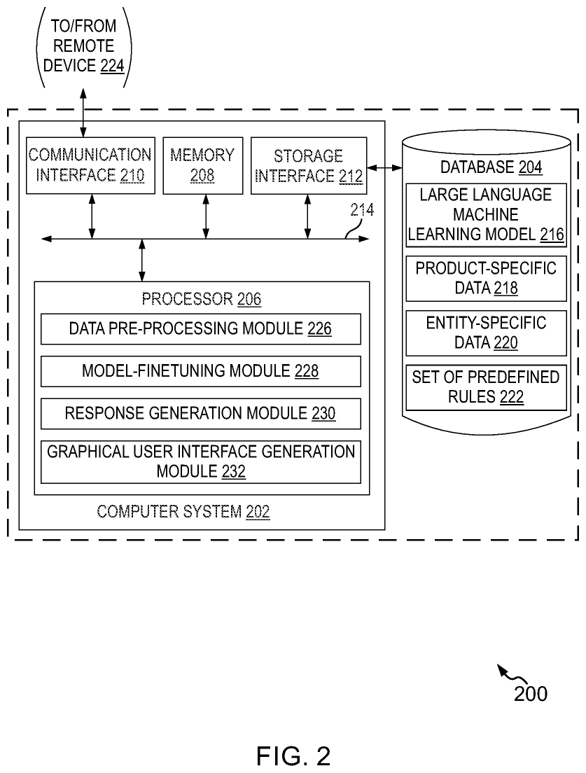

Furthermore, the server system 102 may be configured to perform other operations as well, these operations along with the operations described earlier and explained further in detail with reference to FIG. 2.

It should be understood that the server system 102 is a separate part of the environment 100, and may operate apart from (but still in communication with, for example, via the network 116) any third-party external servers (to access data to perform the various operations described herein). However, in other embodiments, the server system 102 may be incorporated, in whole or in part, into one or more parts of the environment 100.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 116, which may be specifically configured, via executable instructions, to perform steps as described herein, and/or embodied in at least one non-transitory computer-readable media.

FIG. 2 illustrates a simplified block diagram of a server system 200, in accordance with an embodiment of the present disclosure. It is noted that the server system 200 is identical to the server system 102 of FIG. 1. In one embodiment, the server system 200 is a part of the payment network 112 or integrated within the payment server 114. In some embodiments, the server system 200 is embodied as a cloud-based and/or Software as a Service (SaaS) based architecture.

The server system 200 includes a computer system 202 and a database 204. It is noted that the database 204 is identical to the database 120 of FIG. 1. The computer system 202 includes at least one processor 206 (herein, referred to interchangeably as ‘processor 206’) for executing instructions, a memory 208, a communication interface 210, and a storage interface 212 that communicates with each other via a bus 214.

In some embodiments, the database 204 is integrated into the computer system 202. For example, the computer system 202 may include one or more hard disk drives as the database 204. A storage interface 212 is any component capable of providing the processor 206 with access to the database 204. The storage interface 212 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one non-limiting example, the database 204 is configured to store a large language machine learning (LLM) model 216, product-specific data 218, entity-specific data 220, a set of predefined rules 222, and the like. It is noted that the LLM model 216 is identical to the LLM model 122 of FIG. 1.

The processor 206 includes suitable logic, circuitry, and/or interfaces to execute operations for determining one or more suitable products from a plurality of products, determining one or more operating parameters corresponding to the one or more suitable products for performing a task by an entity, and the like. In other words, the processor 206 includes suitable logic, circuitry, and/or interfaces to execute operations for generating a peer set indicating similar entities from the plurality of entities and the like. Examples of the processor 206 include, but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device 224 such as the acquirer server 108, the issuer server 110, the payment server 114, or communicating with any entity connected to the network 116 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a data pre-processing module 226, a model fine-tuning module 228, a response generation module 230, and a graphical user interface (GUI) generation module 232. It should be noted that components, described herein, such as the data pre-processing module 226, the model fine-tuning module 228, the response generation module 230, and the graphical user interface (GUI) generation module 232 can be configured in a variety of ways, including electronic circuitries, digital arithmetic, and logic blocks, and memory systems in combination with software, firmware, and embedded technologies.

In an embodiment, the data pre-processing module 226 includes suitable logic and/or interfaces for receiving a task-specific query from an entity such as the issuer or the acquirer. The task-specific query may be a query shared by the entity for requesting task-specific information related to one or more suitable products from a plurality of products offered by another entity such as a payment processor to be used for performing a task by the entity. In an implementation, the data pre-processing module 226 may be configured to utilize the GUI generation module 232 which includes suitable logic and/or interfaces for generating various GUIs for facilitating the server system 200 to perform the various operations described herein. For instance, the GUI generation module 232 may generate a GUI and facilitate the display of the generated GUI on an electronic device (not shown) associated with the entity. In various non-limiting examples, the electronic device may refer to any electronic device such as, but not limited to, Personal Computers (PCs), tablet devices, Personal Digital Assistants (PDAs), voice-activated assistants, Virtual Reality (VR) devices, smartphones, and laptops. The GUI may facilitate the entity to transmit the task-specific query to the data pre-processing module 226 of the server system 200 as a prompt.

Upon receiving the task-specific query, the data pre-processing module 226 is configured to determine the task to be performed by the entity based, at least in part, on the received task-specific query. In one implementation, the data pre-processing module 226 may utilize an AI or ML model such as the LLM model 216 to determine the intent of the task-specific query to determine the task to be performed by the entity. In a non-limiting example, the LLM model 216 can be any open-source pre-trained large language or generative model. In an instance, the LLM model 216 may include one or more open-source pre-trained large language models such that one open-source pre-trained model may be selected from the one or more open-source pre-trained large language models based on a task to be performed by an entity such as the issuer or the acquirer. In one instance, the LLM model 216 may be a transformer-based model. In an instance, the LLM model 216 may be trained on open source datasets including EnglishCommonCrawl®, C4®, Github®, Wikipedia®, Gutenburg®, ArXiv®, Stack Exchange® and the like. As may be understood, the task-specific may be a natural language query for requesting the server system 200 to perform an activity (i.e., task). This natural language query has to be analyzed by the data pre-processing module 226 to determine which task the entity wants to perform. To that end, the data pre-processing module 226 may utilize the LLM model 216 to determine the task to be performed by the entity.

Further, the data pre-processing module 226 is configured to access product-specific data 218, entity-specific data 220, and a set of predefined rules 222 from the database 204 based, at least in part, on the entity and the task. In an example, the product-specific data 218 may include information related to each product of the plurality of products. In various non-limiting examples, the information related to each product of the plurality of products may include product-related presentation information, product-related confluence page information, and product-related management information. It is understood that product-related presentation information includes information extracted from a plurality of presentations or marketing material generated for each product during its creation and deployment stage. Further, the product-related confluence pages information represents information extracted from a plurality of confluence pages associated with each product. It is noted that confluence pages refer to the workspace of teams working collaboratively on a product during its creation and deployment stage. Furthermore, the product-related management information represents information extracted from the work (i.e., notes, observations, and so on) of a product manager responsible for the product.

In an example, entity-specific data 220 includes information related to the entity. In some scenarios, the entity-specific data 220 may be collected from the entity over a period of time during which the entity has associated with the payment processor on a variety of projects. In other scenarios, the entity-specific data 220 may describe the requirements of the entity such as regulatory requirements due to the location of the entity, preferences of the entity, technical capability of the entity to implement the products, and the like. In an example, the set of predefined rules represents rules for implementing the plurality of products. For instance, the set of predefined rules may include rule decision combinations associated with a variety of products such as Fraud Rule Manager® and the like.

In another embodiment, the data pre-processing module 226 is communicably coupled to the model fine-tuning module 228 and is configured to transmit or share the product-specific data 218, the entity-specific data 220, and the set of predefined rules 222 with the model fine-tuning module 228.

In an embodiment, the model fine-tuning module 228 includes suitable logic and/or interfaces for generating or fine-tuning the LLM model 216. In particular, the model fine-tuning module 228 is configured to train or fine-tune the LLM model 216 based, at least in part, on the product-specific data 218 and the entity-specific data 220. Herein, the LLM model 216 is fine-tuned to identify one or more suitable products for performing the task by the entity. Then, the model fine-tuning module 228 is configured to determine via the LLM model 216, the task-specific information related to the one or more suitable products based, at least in part, on the set of predefined rules 222. It is noted that the model fine-tuning process has been described in detail later with reference to FIG. 3.

In another embodiment, the model fine-tuning module 228 is communicably coupled to the response generation module 230 and is configured to share the LLM model 216 with the response generation module 230.

In an embodiment, the response generation module 230 includes suitable logic and/or interfaces for generating a query response message based, at least in part, on the product-specific data 218, the entity-specific data 220, and the set of predefined rules 222. In various non-limiting examples, AI or ML models may be utilized for generating the query response message. In a particular implementation, the response generation module 230 is configured to generate via the LLM model 216, a query response message based, at least in part, on the product-specific data 218, the entity-specific data 220, and the set of predefined rules 222. It is noted that the query response message may include task-specific information related to one or more suitable products for performing the task. In a non-limiting example, the task-specific information may include at least a list of the one or more suitable products and the one or more operating parameters corresponding to each suitable product of the one or more suitable products for performing the task.

In various examples, the one or more operating parameters corresponding to each suitable product may include at least a threshold value for each suitable product for performing the task by the entity. For instance, if a fraud management product is selected by the LLM model 216 in response to the query of the entity, such that the product is responsible for generating AI scores indicating whether a transaction is fraud or non-fraud. Then, the operating parameters for this fraud management product may be a threshold value above which the transaction may be labeled as fraud and below which the transaction may be labeled as non-fraud. To that end, the query response message may indicate the product name along with the threshold values required for labeling the transaction as fraud or non-fraud.

As may be understood, the query response message is a natural language message that describes the use of the product suitable for the requirements of the entity. In other words, the query response message includes task-specific information that is adapted into natural language that may be understood by the user (or the administrator associated with the issuer or acquirer). In particular, the response generation module 230 is configured to inject context to the LLM model 216 as an input to improve the query response message generated by the LLM model 216. In an embodiment, the context may include additional text or information that provides context for the prompt shared by the entity which allows the LLM model 216 to respond accordingly with the query response message. For instance, the task-specific query or prompt may be “IDENTIFY CARDS AT HIGH RISK OF FRAUD DUE TO DATA BREACH.” In this case, the additional information or context provided by the response generation module 230 may be “THE OUTPUT SHOULD MENTION ONE OF THE AI RISK SCORES AND THE THRESHOLD WHICH HELPS TO IDENTIFY SUCH CARDS.” In this scenario, the output query response message generated by the LLM model 216 may be “ACCOUNT DATA COMPROMISE SCORE ABOVE THE THRESHOLD 0.85 CAN HELP TO IDENTIFY CARDS AT HIGH RISK OF FRAUD DUE TO DATA BREACH.”

Moreover, the response generation module 230 is configured to extract numerical values for one or more operating features from the LLM model 216. Further, the response generation module 230 is configured to check the probability associated with the query response message (i.e., the out of the LLM model 216). In an embodiment, if the output probability is at least equal (i.e., greater than or equal to) than a predefined threshold value then, the query response message may be transmitted to the entity in response to the task-specific query. In an alternative embodiment, if the output probability is lower than the predefined threshold value then, an error message is shared with the entity. The error message indicates that the LLM model 216 has low confidence in its output. It is noted that injecting additional context to the LLM model 216 and reinforcing the output by including numerical values helps to avoid the problem of factual hallucination faced for large language or generative models, thereby improving the output generated by these models.

More specifically, the response generation module 230 is configured to at first, feed or share the initial prompt (i.e., the task-specific query) received from the entity to the LLM model 216 as an input. Further, the response generation module 230 is configured to generate a contextual prompt based, at least in part, on determining the context of the initial prompt. For instance, Natural language processing (NLP) based machine learning models may be used to determine the context of the initial prompt. It is understood that the contextual prompt is generated such that it can reinforce or force the LLM model 216 to focus on numerical values beyond a certain threshold, thereby eliminating factual hallucination. In an example, if the initial prompt is ‘IDENTIFY CARDS AT LOW RISK OF FRAUD DUE TO DATA BREACH.’ Then, the response generation module 230 may determine that the context behind this initial prompt is to risk associated with payment cards, the risk is due to data breach, and to identify cards with low risk.

Therefore, the response generation module 230 may generate a contextual prompt such as ‘THE OUTPUT SHOULD MENTION ONE OF THE AI RISK SCORES AND THE THRESHOLD WHICH HELPS TO IDENTIFY SUCH CARDS WITH LOW RISK.’ As may be understood, the first portion of the contextual prompt forces the LLM model 216 to actually select a suitable product (or a list of one or more suitable products) from the plurality of products offered by the payment processor. Furthermore, the second portion of the contextual prompt forces the LLM model 216 to provide one or more operating parameters corresponding to each suitable product. As may be understood, since LLM models are conversational models they are inherently able to understand to context between different prompts during the same conversation instance. To that end, the LLM model 216 is also able to correlate between the initial prompt and the subsequent contextual prompt to determine the exact requirements of the entity. In other words, the contextual prompt (may also be called an operating parameter prompt or threshold prompt) helps the LLM model 216 to focus on numerical values beyond a particular threshold, i.e., the exemplary prompt regarding the requirement for AI risk scores helps the LLM model 216 to look at particular AI risk scores satisfying the criteria given by the contextual prompt. This aspect is possible since LLM models use an attention mechanism that helps them to search for data in a particular context provided by the user (in this scenario, i.e., the entity).

In an implementation, the response generation module 230 may be configured to utilize the graphical user interface (GUI) generation module 232 which includes suitable logic and/or interfaces for generating various GUIs for facilitating the server system 200 to perform the various operations described herein as well. For instance, the GUI generated by the GUI generation module 232 may facilitate the response generation module 230 to display the query response message on the GUI in response to the prompt of the task-specific query.

FIG. 3 illustrates a schematic representation 300 of the architecture of the LLM model such as LLM model 216, in accordance with an embodiment of the present disclosure.

As may be understood, LLM models are typically built using a transformer architecture. Using the transformer architecture, an LLM model such as LLM model 216 can tokenize an input prompt (such as the task-specific query) into smaller units. For instance, a sentence of the input prompt (depicted as inputs 302) may be tokenized by the LLM model 216 into words or sub-words. Further, each token from the plurality of tokens generated for the initial prompt is converted to an embedding. This embedding is shown as input embedding 304 in FIG. 3. As may be understood, these embeddings capture the meaning and context of the various words forming the sentence of the initial prompt.

Typically, since transformers do not pay attention to the word order in a sentence, positional encodings have to be added to the embeddings to enforce information about the position of each word in the sequence within the sentence of the input prompt. The addition of positional encoding to the input embedding 304 is depicted by operator 306. Thereafter, the embeddings are fed to a multi-head self-attention mechanism or multi-head attention (see, 308). The multi-head self-attention mechanism allows the LLM model 216 to weigh the importance of different words in the sequence when making predictions. In other words, the multi-head self-attention mechanism enables the LLM model 216 to capture the dependencies between words in a sequence, regardless of the distance between the words within the sequence from each other.

It is noted that the self-attention mechanism computes a weighted sum of all input embeddings where the weights are determined based, at least in part, on the relevance of each word to the current word in the sequence. As may be understood, the self-attention mechanism is configured to compute attention scores using a learned set of parameters (known, as attention weights). The result is a context vector for each word, i.e., a representation of each token that captures contextual information by considering all other words in the sequence within the sentence. To enhance the capacity of the self-attention mechanism, the transformer architecture uses multi-head attention (see, 308). To that end, instead of having a single set of attention weights, the LLM model 216 uses multiple heads (or sets) of attention weights. Each head learns to attend to different parts of the input sequence and captures different aspects of the context. Further, the outputs of the multiple attention heads are concatenated and linearly transformed to produce the final attention output.

Thereafter, the representation of each token is passed through a feed-forward neural network (see, 310). The feed-forward neural network 310 generally consists of fully connected layers with various activation functions such as Rectified Linear Unit (ReLu), and further, the feed-forward neural network 310 is configured to learn complex transformations of the data.

It is noted that layer normalization and residual connections are used by the transformer architecture to stabilize the training of the LLM model 216 thereby, enabling the LLM model 216 to learn effectively. It is understood that residual connections allow gradients to flow more easily through the neural network.

In particular, add and norm layers (see, 312 and 314) are added to each sub-layer of the multi-layer neural network for performing the layer normalization and residual connections. Process. The ‘ADD’ step adds the original input of a sub-layer to the output from that sub-layer to generate a new output. Mathematically, this can be shown as Output=Sublayer (input)+Input, herein sublayer (input) is a function that represents the initial output from the sub-layer. The goal of the ADD step is to form residual connections thus, allowing gradients to flow more easily during training. This helps mitigate the vanishing gradient problem, making it easier to train very deep networks. Further, the ADD step ensures that the neural network doesn't completely replace the original input but rather refines it. This is important because the original input contains valuable information about the input sequence. Once, the ADD step is concluded, NORM (i.e., Normalization) step is applied to the output from the sub-layer. Layer normalization is a technique used to stabilize and speed up training in deep neural networks by normalizing the activations of each neuron. Mathematically, layer normalization can be represented as Output=LayerNorm (Sublayer (Input)+Input). The NORM step normalizes the activation of neurons of the sub-layer of the neural network, ensuring their mean is zero and standard deviation is one. This aspect helps the gradient from becoming too small or too large during back-propagation.

Further, it is understood that transformers typically consist of multiple identical layers stacked on top of each other (shown by block 316). For instance, Nₓ number of layers are present in the stack of layers within the transformer architecture. Each layer refines the representations learned in the previous layers. It is noted that the various layers in block 316 are identical to the layers shown with reference to block 318, therefore they are not explained again for the sake of brevity. These stacks of layers are divided into encoder stacks and decoder stacks. Herein, the encoder stack is responsible for processing the input sequence (e.g., the task-specific query) and creating context representations; whereas the decoder stack is responsible for generating the output sequence (e.g., the query response message) based on the context representations created by the encoder stack.

Furthermore, ‘Linear’ and ‘Softmax’ operations are used at the final layer of the transformer architecture for the sequence-to-sequence tasks such as responding to prompts from a user. The Linear operation (see, 320) is a neural network layer that performs a linear transformation on its input. It is typically used to project the context representations learned by the transformer architecture into a space where each dimension corresponds to a specific token or word in a target vocabulary (or dictionary). The terms “target dictionary” or “target vocabulary” refer to a predefined set of words or tokens that the LLM model 216 is expected to generate as output.

The Softmax operation (see, 322) is applied to the scores produced by the linear layer. Softmax is used to convert these scores into a probability distribution over the target vocabulary. It ensures that the values in the distribution are positive and sum to 1, making it interpretable as probabilities. The result of the Softmax operation (see, 322) is a probability distribution where each value represents the likelihood of a specific token being the next word in the output sequence. The output embedding (see, 324) is the learned representation of tokens from the sentence of the initial prompt. The output embedding 324 represents a sequence of hidden state vectors generated by encoder segment of transformer architecture. Further, the output probabilities (see, 326) refer to the probabilities associated with each token in the sentence of the initial prompt for a given position in the output sequence (see, outputs 328). In other words, the output probabilities 326 is a distribution over the vocabulary that contains all the words along with different probabilities that describe or indicate how likely is a given work to occur in the sequence of words in the current inputs 302. These probabilities are computed using the Softmax activation function and are used to determine the likelihood of each token being the next word in the output sequence. Herein, the output (shifted right) 328 are output embeddings that are offset by one position to ensure that predictions for position ‘i’ can only depend on known outputs less than position ‘i’.

To reiterate, the following intermediate steps are performed before sending data to the LLM model 216 for fine-tuning:
Pre-processing input prompt: Human language sentences are broken down into words. These words are converted to tokens. In some instances, a dictionary of word to token embeddings is maintained.
Post-processing: Output tokens generated by the LLM model 216 are converted back to the Human language using the same dictionary of word to token embeddings.
LLM model: The LLM model 216 uses a combination of self-attention, transformers, encoders, and decoders. Self-attention helps the LLM to assign different weights to different words which helps to capture context. Transformers help to capture complex relationships in the language. Encoders and decoders help to compress information and keep relevant information.

The training of the LLM model 216 generally consists of two phases, namely, the pre-training phase and the fine-tuning phase.

During the pre-training phase, the LLM model 216 is trained on a large generic dataset obtained from various sources. It is understood that the goal of this pre-training phase, the LLM model 216 is allowed to predict the next word in a sentence given the context. To achieve this, some words in the training data are randomly masked, while the model objective is set to predict these masked words correctly. This process is known as masked language modeling. In this particular instance, the LLM model 216 is also trained on custom prompts accessed from the payment processor. A few examples of the custom prompt as given as follows:

{
″id″: ″1″,
″ Query response message″: [
{
″from″: ″human″,
″PROMPT″: ″Prevent fraud due to high activity at a merchant″
},
{
″from″: ″LLM model″,
″Value″: “Account merchant activity risk score and decision intelligence score can help
to prevent fraud due to high activity at a merchant.″
}
]
},
{
″id″: ″2″,
″Query response message″: [
{
″from″: ″human″,
″PROMPT″: ″Provide threshold for each score.″
},
{
″from″: ″gpt″,
″Value″: “Account merchant activity risk score greater than 0.67 and decision
intelligence score above 900 can help to prevent fraud due to high activity at a
merchant.″
}
]
}

Once, the pre-training phase is completed, the LLM model 216 goes through the fine-tuning phase. In the fine-tuning stage, the LLM model 216 is trained on product-specific data, entity-specific data, and a set of predefined rules. The LLM model 216 is fine-tuned to perform the task of generating a query response message in response to the task-specific query received from an entity. Further, the LLM model 216 is evaluated based on a variety of ML model evaluation techniques to optimize the various neural network parameters associated with the LLM model 216.

As may be understood, once the training and evaluation process of the LLM model 216 is completed, the LLM model 216 can be deployed in various applications such as chat assistants. It is understood that once an LLM model 216 is deployed as a chat assistant it can be configured to respond to queries or prompts from any entity specific to the plurality of products offered by the payment processor since the LLM model 216 has been fine-tuned on the product-specific data, entity-specific data, and a set of predefined rules. It is understood that the various operations of the LLM model 216 described herein are performed using the various components or modules of the server system 200.

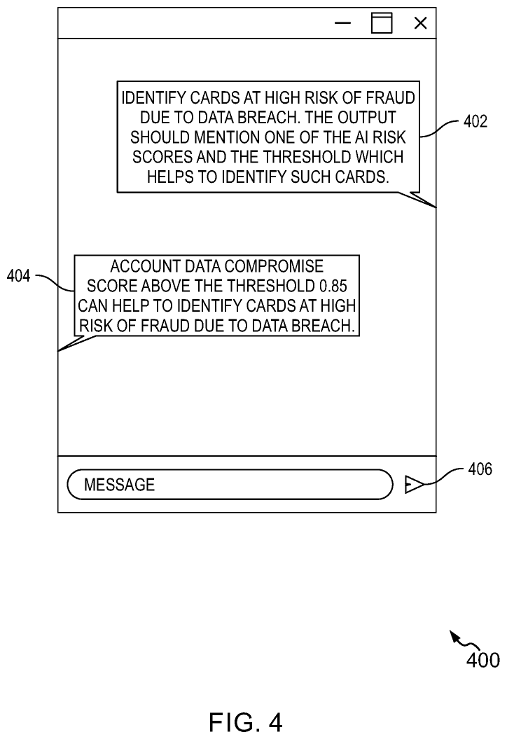

FIG. 4 illustrates a Graphical User Interface (GUI) 400 in accordance with various embodiments of the present disclosure. As depicted, the GUI 400 depicts a conversation between the entity and the AI model such as LLM model 216. As described earlier, the server system 200 facilitates the display of the GUI 400 and enables the entity to communicate with the LLM model 216 of the server system 200. At first, the entity prompts a task-specific query (see, 402), as depicted the entity prompts “IDENTIFY CARDS AT HIGH RISK OF FRAUD DUE TO DATA BREACH. THE OUTPUT SHOULD MENTION ONE OF THE AI RISK SCORES AND THE THRESHOLD WHICH HELPS TO IDENTIFY SUCH CARDS” on the GUI 400. In response to receiving the task-specific query 402, the server system 200 utilizes the LLM model 216 to generate a query response message (see, 404). In particular, the server system 200 generates word tokens and processes the word tokens as model inputs. Then pre-processed input is then fed to LLM model 216 for generating the query response message. Thereafter, the LLM model 216 is configured to generate word tokens and arrange them in the form of a sentence. This sentence is then post-processed by the LLM model 216 to generate the query response message in human language. Further, the server system is configured to facilitate the transmission of the query response message (see, 404) to the entity through the GUI 400. As depicted, the server system 200 responds with “ACCOUNT DATA COMPROMISE SCORE ABOVE THE THRESHOLD 0.85 CAN HELP TO IDENTIFY CARDS AT HIGH RISK OF FRAUD DUE TO DATA BREACH.”. Similarly, other prompts and responses may also be exchanged between the entity and the server system 200 depending on the tasks and requirement of the entity. In an example, the entity may prompt the server system 200 by asking “IDENTIFY CARDS AT HIGH RISK OF FRAUD DUE TO DATA BREACH.” and the server system 200 may respond by answering “ACCOUNT DATA COMPROMISE SCORE CAN HELP TO IDENTIFY CARDS AT HIGH RISK OF FRAUD DUE TO DATA BREACH”. In another example, the entity may prompt the server system 200 by asking “IDENTIFY CARDS DOING EXCESSIVE CHARGEBACKS IN NEXT 3 MONTHS.” and the server system 200 may respond by answering “EXCESSIVE CHARGEBACK FRAUD RISK SCORE CAN HELP TO IDENTIFY CARDS DOING EXCESSIVE CHARGEBACKS IN NEXT 3 MONTHS”. In yet another example, the entity may prompt the server system 200 by asking “IDENTIFY CARDS LIKELY TO EXPERIENCE INSUFFICIENT FUNDS.” and the server system 200 may respond by answering “ACCOUNT PAYMENT CAPACITY RISK SCORE CAN HELP TO IDENTIFY ACCOUNTS LIKELY TO EXPERIENCE INSUFFICIENT FUNDS AND COMMIT FRAUD”.

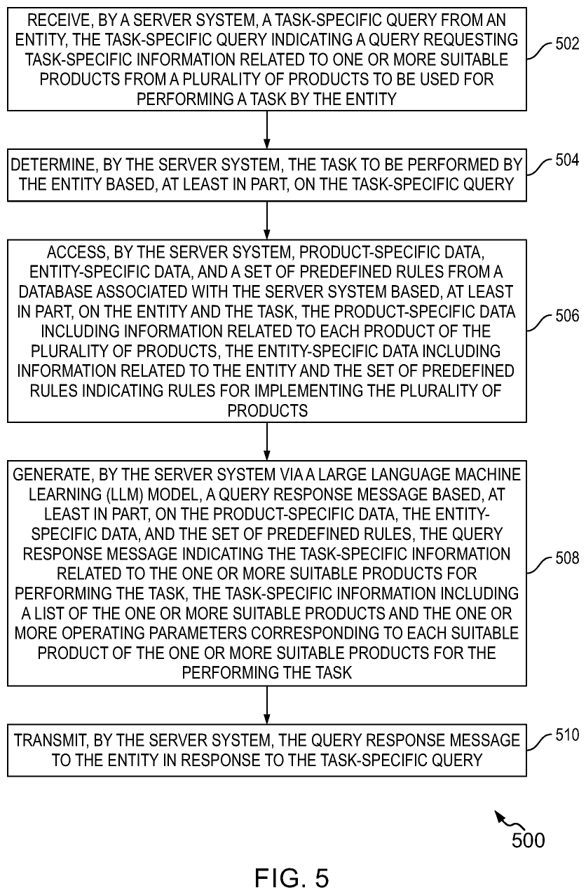

FIG. 5 illustrates a process flow diagram depicting a method 500 for generating a query response message in response to a task-specific query from an entity for performing a task, in accordance with an embodiment of the present disclosure. The method 500 depicted in the flow diagram may be executed by, for example, the server system 200. The sequence of operations of the method 500 may not be necessarily executed in the same order as they are presented. Further, one or more operations may be grouped and performed in the form of a single step, or one operation may have several sub-steps that may be performed in parallel or in a sequential manner. Operations of the method 500, and combinations of operations in the method 500 may be implemented by, for example, hardware, firmware, a processor, circuitry, and/or a different device associated with the execution of software that includes one or more computer program instructions. The plurality of operations is depicted in the process flow of the method 500. The process flow starts at operation 502.

At 502, the method 500 includes receiving, by a server system 200, a task-specific query from an entity (such as an issuing bank or an acquiring bank), the task-specific query indicating a query requesting task-specific information related to one or more suitable products from a plurality of products to be used for performing a task by the entity.

At 504, the method 500 includes accessing, by the server system 200, the task to be performed by the entity based, at least in part, on the task-specific query.

At 506, the method 500 includes determining, by the server system 200, product-specific data 218, entity-specific data 220, and a set of predefined rules 220 from a database such as database 204 associated with the server system 200 based, at least in part, on the entity and the task, the product-specific data 218 including information related to each product of the plurality of products, the entity-specific data 220 including information related to the entity and the set of predefined rules 222 indicating rules for implementing the plurality of products.

At 508, the method 500 includes generating, by the server system 200 via a Large Language Machine learning (LLM) model such as LLM model 216, a query response message based, at least in part, on the product-specific data 218, the entity-specific data 220, and the set of predefined rules 222, the query response message indicating the task-specific information related to the one or more suitable products for performing the task, the task-specific information including a list of the one or more suitable products and the one or more operating parameters corresponding to each suitable product of the one or more suitable products for performing the task.

At 510, the method 500 includes transmitting, by the server system 200, the query response message to the entity in response to the task-specific query.

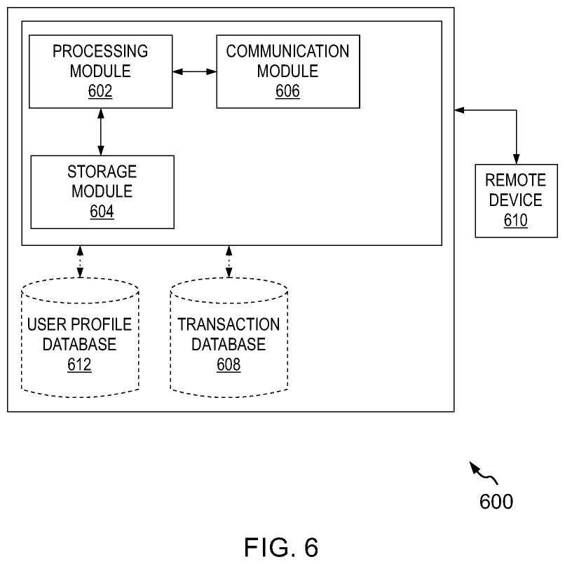

FIG. 6 illustrates a simplified block diagram of the acquirer server 600, in accordance with an embodiment of the present disclosure. The acquirer server 600 is an example of the acquirer server 108 of FIG. 1. The acquirer server 600 is associated with an acquirer bank/acquirer, in which a merchant may have an account. The acquirer server 600 includes a processing module 602 operatively coupled to a storage module 604 and a communication module 606. The components of the acquirer server 600 provided herein may not be exhaustive and the acquirer server 600 may include more or fewer components than those depicted in FIG. 6. Further, two or more components may be embodied in one single component, and/or one component may be configured using multiple sub-components to achieve the desired functionalities. Some components of the acquirer server 600 may be configured using hardware elements, software elements, firmware elements, and/or a combination thereof.

The storage module 604 is configured to store machine-executable instructions to be accessed by the processing module 602. Additionally, the storage module 604 stores information related to, the contact information of the merchant, bank account number, availability of funds in the account, payment card details, transaction details, and/or the like. Further, the storage module 604 is configured to store payment transactions.

In one embodiment, the acquirer server 600 is configured to store profile data (e.g., an account balance, a credit line, details of the merchant such as merchant 106(1), account identification information) in a transaction database 608. The details of the merchant 106(1) may include, but are not limited to, merchant name, age, gender, physical attributes, location, registered contact number, family information, alternate contact number, registered e-mail address, Merchant Category Code (MCC), merchant industry, merchant type, etc.

The processing module 602 is configured to communicate with one or more remote devices such as a remote device 610 using the communication module 606 over a network such as the network 116 of FIG. 1. The examples of the remote device 610 include the server system 102, the payment server 114, the issuer server 110, or other computing systems of the acquirer server 600, and the like. The communication module 606 is capable of facilitating such operative communication with the remote devices and cloud servers using Application Program Interface (API) calls. The communication module 606 is configured to receive a payment transaction request performed by the cardholder 104(1) of the cardholder 104 via the network 116. The processing module 602 receives payment card information, a payment transaction amount, and cardholder information from the remote device 610 (i.e., the payment server 114). The acquirer server 600 includes a user profile database 612 and the transaction database 608 for storing transaction data. The user profile database 612 may include information of the merchants. The transaction data may include, but is not limited to, transaction attributes, such as transaction amount, source of funds such as bank or credit cards, transaction channel used for loading funds such as POS terminal, transaction velocity features such as count and transaction amount sent in the past x days to a particular user, transaction location information, external data sources, and other internal data to evaluate each transaction.

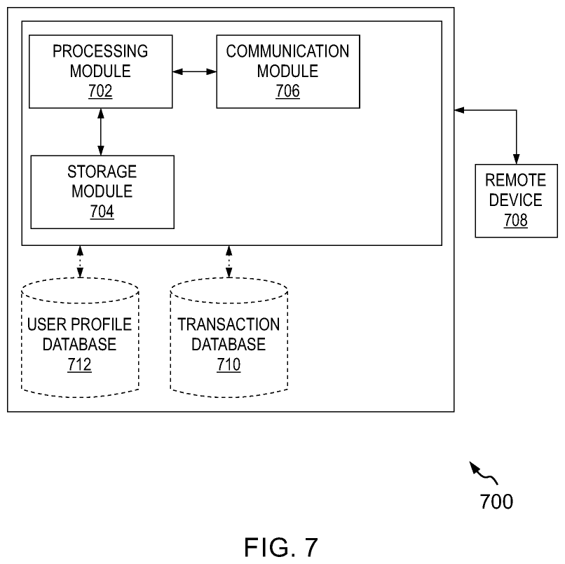

FIG. 7 illustrates a simplified block diagram of the issuer server 700, in accordance with an embodiment of the present disclosure. The issuer server 700 is an example of the issuer server 110 of FIG. 1. The issuer server 700 is associated with an issuer bank/issuer, in which an account holder (e.g., the cardholder 104) may have an account, which provides a payment card (e.g., the payment card 118). The issuer server 700 includes a processing module 702 operatively coupled to a storage module 704 and a communication module 706. The components of the issuer server 700 provided herein may not be exhaustive and the issuer server 700 may include more or fewer components than those depicted in FIG. 7. Further, two or more components may be embodied in one single component, and/or one component may be configured using multiple sub-components to achieve the desired functionalities. Some components of the issuer server 700 may be configured using hardware elements, software elements, firmware elements, and/or a combination thereof.

The storage module 704 is configured to store machine-executable instructions to be accessed by the processing module 702. Additionally, the storage module 704 stores information related to, the contact information of the cardholders (e.g., the cardholder 104), a bank account number, availability of funds in the account, payment card details, transaction details, payment account details, and/or the like. Further, the storage module 704 is configured to store payment transactions.

In one embodiment, the issuer server 700 is configured to store profile data (e.g., an account balance, a credit line, details of the cardholders, account identification information, payment card number, etc.) in a database. The details of the cardholders may include, but are not limited to, name, age, gender, physical attributes, location, registered contact number, family information, alternate contact number, registered e-mail address, or the like of the cardholders, etc.

The processing module 702 is configured to communicate with one or more remote devices such as a remote device 708 using the communication module 706 over a network such as the network 116 of FIG. 1. Examples of the remote device 708 include the server system 200, the payment server 114, the acquirer server 108 or other computing systems of the issuer server 700. The communication module 706 is capable of facilitating such operative communication with the remote devices and cloud servers using API calls. The communication module 706 is configured to receive a payment transaction request performed by an account holder (e.g., the cardholder 104) via the network 116. The processing module 702 receives payment card information, a payment transaction amount, customer information, and merchant information from the remote device 708 (e.g., the payment server 114). The issuer server 700 includes a transaction database 710 for storing transaction data. The transaction data may include, but is not limited to, transaction attributes, such as transaction amount, source of funds such as bank or credit cards, transaction channel used for loading funds such as POS terminal or ATM machine, transaction velocity features such as count and transaction amount sent in the past x days to a particular account holder, transaction location information, external data sources, and other internal data to evaluate each transaction. The issuer server 700 includes a user profile database 712 storing user profiles associated with the plurality of account holders.

The user profile data may include an account balance, a credit line, details of the account holders, account identification information, payment card number, or the like. The details of the account holders (e.g., the cardholder 104) may include, but are not limited to, name, age, gender, physical attributes, location, registered contact number, family information, alternate contact number, registered e-mail address, or the like of the cardholders 104.

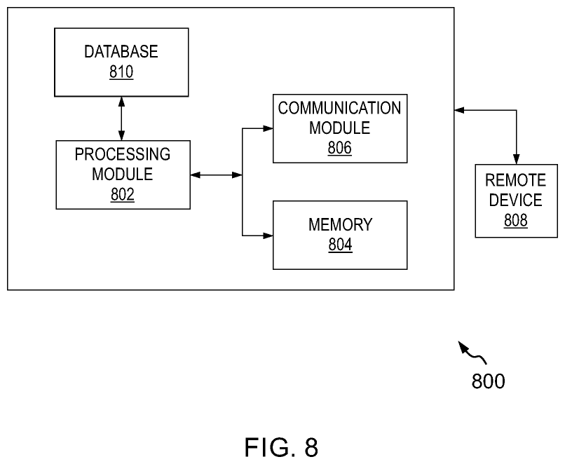

FIG. 8 illustrates a simplified block diagram of the payment server 800, in accordance with an embodiment of the present disclosure. The payment server 800 is an example of the payment server 114 of FIG. 1. The payment server 800 and the server system 200 may use the payment network 112 as a payment interchange network. Examples of payment interchange networks include, but are not limited to, MasterCard® payment system interchange network.

The payment server 800 includes a processing module 802 configured to extract programming instructions from a memory 804 to provide various features of the present disclosure. The components of the payment server 800 provided herein may not be exhaustive and the payment server 800 may include more or fewer components than that depicted in FIG. 8. Further, two or more components may be embodied in one single component, and/or one component may be configured using multiple sub-components to achieve the desired functionalities. Some components of the payment server 800 may be configured using hardware elements, software elements, firmware elements, and/or a combination thereof.

Via a communication module 806, the processing module 802 receives a request from a remote device 808, such as the issuer server 110, the acquirer server 108, or the server system 102. The request may be a request for conducting the payment transaction. The communication may be achieved through API calls, without loss of generality. The payment server 800 includes a database 810. The database 810 also includes transaction processing data such as issuer ID, country code, acquirer ID, and Merchant Identifier (MID), among others.

When the payment server 800 receives a payment transaction request from the acquirer server 108 or a payment terminal (e.g., IoT device), the payment server 800 may route the payment transaction request to an issuer server (e.g., the issuer server 110). The database 810 stores transaction identifiers for identifying transaction details such as transaction amount, IoT device details, acquirer account information, transaction records, merchant account information, and the like.

In one example embodiment, the acquirer server 108 is configured to send an authorization request message to the payment server 800. The authorization request message includes, but is not limited to, the payment transaction request.

The processing module 802 further sends the payment transaction request to the issuer server 110 for facilitating the payment transactions from the remote device 808. The processing module 802 is further configured to notify the remote device 808 of the transaction status in the form of an authorization response message via the communication module 806. The authorization response message includes, but is not limited to, a payment transaction response received from the issuer server 110. Alternatively, in one embodiment, the processing module 802 is configured to send an authorization response message for declining the payment transaction request, via the communication module 806, to the acquirer server 108. In one embodiment, the processing module 802 executes similar operations performed by the server system 200, however, for the sake of brevity, these operations are not explained herein.

The disclosed method with reference to FIG. 5, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means include, for example, the Internet, the World Wide Web (WWW), an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application Specific Integrated Circuit (ASIC) circuitry and/or Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause the processor or the computer to perform one or more operations. A computer-readable medium storing, embodying, or encoded with a computer program, or similar language, may be embodied as a tangible data storage device storing one or more software programs that are configured to cause the processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g. magneto-optical disks), Compact Disc Read-Only Memory (CD-ROM), Compact Disc Recordable (CD-R), compact disc rewritable (CD-R/W), Digital Versatile Disc (DVD), BLU-RAY® Disc (BD), and semiconductor memories (such as mask ROM, programmable ROM (PROM), (erasable PROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based on these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

I/We claim:

1. A computer-implemented method, comprising:
receiving, by a server system, a task-specific query from an entity, the task-specific query indicating a query requesting task-specific information related to one or more suitable products from a plurality of products to be used for performing a task by the entity;
determining, by the server system, the task to be performed by the entity based, at least in part, on the task-specific query;
accessing, by the server system, product-specific data, entity-specific data, and a set of predefined rules from a database associated with the server system based, at least in part, on the entity and the task, the product-specific data comprising information related to each product of the plurality of products, the entity-specific data comprising information related to the entity and the set of predefined rules indicating rules for implementing the plurality of products;
generating, by the server system via a Large Language Machine learning (LLM) model, a query response message based, at least in part, on the product-specific data, the entity-specific data, and the set of predefined rules, the query response message indicating the task-specific information related to the one or more suitable products for performing the task, the task-specific information comprising a list of the one or more suitable products and the one or more operating parameters corresponding to each suitable product of the one or more suitable products for performing the task; and
transmitting, by the server system, the query response message to the entity in response to the task-specific query.

2. The computer-implemented method as claimed in claim 1, wherein receiving the task-specific query, comprises:
facilitating, by the server system, a display of a Graphical User Interface (GUI) on an electronic device associated with the entity, wherein the GUI enables the entity to transmit the task-specific query to the server system as a prompt.

3. The computer-implemented method as claimed in claim 2, further comprising:
facilitating, by the server system, a display of the query response message on the GUI in response to the prompt of the task-specific query.

4. The computer-implemented method as claimed in claim 1, wherein generating the query response message, further comprises:
training, by the server system, the LLM model based, at least in part, on the product-specific data and the entity-specific data, wherein the LLM model is configured to identify the one or more suitable products for performing the task by the entity;
determining, by the server system via the LLM model, the task-specific information related to the one or more suitable products based, at least in part, on the set of predefined rules; and
generating, by the server system, the query response message based, at least in part, on the task-specific information related to the one or more suitable products.

5. The computer-implemented method as claimed in claim 1, wherein the one or more operating parameters corresponding to each suitable product comprises at least a threshold value for each suitable product for performing the task by the entity.

6. The computer-implemented method as claimed in claim 1, wherein the information related to each product of the plurality of products comprises product-related presentation information, product-related confluence pages information, and product-related management information.

7. The computer-implemented method as claimed in claim 1, wherein the LLM model comprises one or more open-source pre-trained large language models.

8. The computer-implemented method as claimed in claim 1, wherein the entity is at least one of an issuer server associated with an issuing bank and an acquirer server associated with an acquiring bank.

9. The computer-implemented method as claimed in claim 1, wherein the server system is a payment server associated with a payment network.

10. A server system, comprising:
a communication interface;
a memory comprising executable instructions; and
a processor communicably coupled to the communication interface and the memory, the processor configured to cause the server system to at least:
receive a task-specific query from an entity, the task-specific query indicating a query requesting task-specific information related to one or more suitable products from a plurality of products to be used for performing a task by the entity;
determine the task to be performed by the entity based, at least in part, on the task-specific query;
access product-specific data, entity-specific data, and a set of predefined rules from a database associated with the server system based, at least in part, on the entity and the task, the product-specific data comprising information related to each product of the plurality of products, the entity-specific data comprising information related to the entity and the set of predefined rules indicating rules for implementing the plurality of products;
generate via a Large Language Machine learning (LLM) model, a query response message based, at least in part, on the product-specific data, the entity-specific data, and the set of predefined rules, the query response message indicating the task-specific information related to the one or more suitable products for performing the task, the task-specific information comprising a list of the one or more suitable products and the one or more operating parameters corresponding to each suitable product of the one or more suitable products for performing the task; and
transmit the query response message to the entity in response to the task-specific query.

11. The server system as claimed in claim 10, wherein to receive the task-specific query, the server system is further caused to:
facilitate a display of a Graphical User Interface (GUI) on an electronic device associated with the entity, wherein the GUI enables the entity to transmit the task-specific query to the server system as a prompt.

12. The server system as claimed in claim 11, wherein the server system is further caused, at least in part, to:
facilitate a display of the query response message on the GUI in response to the prompt of the task-specific query.

13. The server system as claimed in claim 10, wherein to generate the query response message, the server system is further caused, at least in part, to:
train the LLM model based, at least in part, on the product-specific data and the entity-specific data, wherein the LLM model is configured to identify the one or more suitable products for performing the task by the entity;
determine via the LLM model, the task-specific information related to the one or more suitable products based, at least in part, on the set of predefined rules; and
generate the query response message based, at least in part, on the task-specific information related to the one or more suitable products.

14. The server system as claimed in claim 10, wherein the one or more operating parameters corresponding to each suitable product comprises at least a threshold value for each suitable product for performing the task by the entity.

15. The server system as claimed in claim 10, wherein the information related to each product of the plurality of products comprises product-related presentation information, product-related confluence pages information, and product-related management information.

16. The server system as claimed in claim 10, wherein the LLM model comprises one or more open-source pre-trained large language models.

17. The server system as claimed in claim 10, wherein the entity is at least one of an issuer server associated with an issuing bank and an acquirer server associated with an acquiring bank.

18. A non-transitory computer-readable storage medium comprising computer-executable instructions that, when executed by at least a processor of a server system, cause the server system to perform a method comprising:
receiving a task-specific query from an entity, the task-specific query indicating a query requesting task-specific information related to one or more suitable products from a plurality of products to be used for performing a task by the entity;
determining the task to be performed by the entity based, at least in part, on the task-specific query;
accessing product-specific data, entity-specific data, and a set of predefined rules from a database associated with the server system based, at least in part, on the entity and the task, the product-specific data comprising information related to each product of the plurality of products, the entity-specific data comprising information related to the entity and the set of predefined rules indicating rules for implementing the plurality of products;
generating via a Large Language Machine learning (LLM) model, a query response message based, at least in part, on the product-specific data, the entity-specific data, and the set of predefined rules, the query response message indicating the task-specific information related to the one or more suitable products for performing the task, the task-specific information comprising a list of the one or more suitable products and the one or more operating parameters corresponding to each suitable product of the one or more suitable products for performing the task; and
transmitting the query response message to the entity in response to the task-specific query.

19. The non-transitory computer-readable storage medium as claimed in claim 18, wherein receiving the task-specific query comprises:
facilitating a display of a Graphical User Interface (GUI) on an electronic device associated with the entity, wherein the GUI enables the entity to transmit the task-specific query to the server system as a prompt; and
facilitating a display of the query response message on the GUI in response to the prompt of the task-specific query.

20. The non-transitory computer-readable storage medium as claimed in claim 18, wherein generating the query response message further comprises:
training the LLM model based, at least in part, on the product-specific data and the entity-specific data, wherein the LLM model is configured to identify the one or more suitable products for performing the task by the entity;
determining via the LLM model, the task-specific information related to the one or more suitable products based, at least in part, on the set of predefined rules; and
generating the query response message based, at least in part, on the task-specific information related to the one or more suitable products.
